(19) United States
(12) Patent Application Publication
(10) Pub. No.: US 2007/0193139 A1
(43) Pub. Date: Aug. 23, 2007

(54) Panel installation system

(75) Inventor: Michael John Hancock, Hamilton (NZ)

Correspondence Address: BROOKS KUSHMAN P.C., 1000 TOWN CENTER, TWENTY-SECOND FLOOR, SOUTHFIELD, MI, 48075, US

(73) Assignee: HPJ HOLDINGS LIMITED, Hamilton (NZ)

(21) Appl. No.: 10/598,746

(22) PCT Filed: Mar. 10, 2005
(86) PCT No.: PCT/NZ05/00043

§ 371 Date: Sep. 11, 2006

(30) Foreign Application Priority Data
Mar. 11, 2004 (NZ) 531713
Dec. 2, 2004 (NZ) 536989

(51) Int. Cl. E06B 3/964

(52) U.S. Cl. 52/204.62

(57) ABSTRACT

The present invention relates to a panel carriage which is adapted to traverse a pair of rails used to form a track within a joinery system. The carriage includes a main body and at least a pair of wheels, with the wheels of each pair being located on opposite sides of the main body. The panel carriage also includes an adjustable linkage associated with each wheel, where such an adjustable linkage or linkages are adapted to locate at least one wheel on a side of the main body, and a linkage is also adapted to allow movement of a wheel towards and away from the main body.

### TECHNICAL FIELD

This invention relates to an improved panel installation system and also preferably an improved mechanism for removing such panels after installation. Reference throughout this specification will also be made to the present invention being implemented in relation to sliding panels provided in conjunction with aluminium joinery systems. However, those skilled in the art should appreciate that other configurations of the present invention are also envisioned, which need not necessarily rely on aluminium joinery systems.

### BACKGROUND ART

Panel based windows and doors can be constructed and installed relatively quickly and also at a relatively low cost. For example, aluminium based joinery systems may provide a series of profiles or forms which can receive and locate glazing panels. Panel based systems allow a window or doorway to be formed both quickly and at any time after the joinery involved is installed.

It is preferable or of advantage to be able to easily insert panels into or subsequently remove panels from joinery. For example, in the case of some high-rise constructions, building regulations require that glazing panels to be installed much later than the actual joinery required to receive the glazing panels. It is also preferable in some instances to have joinery free and clear of panels during the construction of a building to allow easy access to other related or adjacent components of the structure.

It is also of advantage in some instances to have the capacity to remove and subsequently replace the panels in a door or window during the useful lifespan of the component involved. For example, in the case of aluminium joinery systems which receive glazing panels, it is preferable to occasionally remove the panels from the joinery to allow the exposed surfaces of the joinery to be cleaned and for maintenance or repair work to be completed.

Two common types of joinery systems are normally used to implement sliding panel systems. However, the additional components and mechanisms employed to provide sliding panels can complicate the insertion and removal of such panels.

In the case of aluminium joinery systems, bottom sliding panels have been developed which employ a rolling wheel or carriage assembly attached to the base of a panel. The weight of the panel is supported by the carriage wheels which normally run the length of the joinery in a track or channel provided in a sill or base profile. Bottom rolling panels are removed by normally lifting the panel upwards so that its attached carriage clears the channel provided in the joinery sill, allowing the panel to be pivoted out of its joinery surround.

However, this approach requires that a head space or gap be provided in the top head profile of the joinery to allow the bottom of the panel to be lifted out far enough for its carriage to clear the sill surrounds. This design requirement can increase the overall size and complexity of the joinery in addition to increasing the material cost associated with providing a larger head profile.

An alternative form of sliding panel is the top sliding panel system. Top sliding panels use a carriage which runs on dual rails on opposite sides of an internal cavity of the joinery head profile.

The provision of the track in the head profile eliminates the track in the sill profile which can collect dirt, dust and other contaminants over time and which can detract from the aesthetic appeal of the finished joinery system. Top sliding panels conversely have the track assembly employed hidden within the interior of the head profile and include a flat or sloping exposed sill surface which is easy for a user to clean, and which potentially provides a greater aesthetic appeal.

However, a significant problem associated with such top rolling panels is the difficulty of inserting and removing the top rolling wheel or bearing carriage assembly into and removing same from out of the internal track of the head profile. The normal solution to this problem is to machining a wheel hole or notch in the head profile to form a gap in the tracks through which the wheels or of the carriage can be dropped. However, as can be appreciated by those skilled in the art, such wheel notches create an unattractive or unappealing finish and also require additional manufacturing time and labour to form. These wheel notches are also relatively difficult to use and require precise manoeuvring of a panel to ensure that it can be subsequently installed into and removed from a joinery surround.

It would be of advantage to have an improved joinery system and mechanism for inserting or removing panels into same which addressed any or all of the above problems. In particular, it would be of advantage to have an improved system or mechanism for inserting and removing top rolling sliding panels which did not require a wheel notch in the head profile of the joinery as discussed above, and which also allowed the panel to be easily inserted and removed from the joinery provided.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention it is provided a panel carriage adapted to traverse a pair of rails forming a track within a joinery system, the carriage including,

a main body, and

at least one pair of wheels, with a wheel of each pair being located on opposite sides of the main body, and

an adjustable linkage associated with each wheel, said adjustable linkage or linkages being adapted to locate at least one wheel on a side of the main body,

wherein an adjustable linkage allows movement of a wheel towards and away from the main body.

According to another aspect of the present invention it is provided a panel carriage substantially as described above which also includes a wheel retention means adapted to position at least one wheel with respect to the main body.

According to a further aspect of the present invention there is provided a panel carriage substantially described above which also include a wheel retention means formed by at least one biasing means,

said at least one biasing means associated with each pair of wheels,

said at least one biasing means being adapted to apply a continuous biasing force to urge a wheel or wheels away from the main body,

wherein the biasing force applied is adapted to be overcome by an external force acting to move a wheel towards the body.

According to yet another aspect of the present invention whereas provided a panel carriage substantially as described above which includes at least one locking mechanism is adapted to lock a wheel at a fixed maximum distance away from the main body.

According to an additional aspect of the present invention there is provided a panel carriage substantially as described above, wherein an adjustable linkage includes at least one axle associated with at least one wheel.

According to a further aspect of the present invention there is provided a panel carriage substantially as described above wherein an adjustable linkage is formed by or includes at least one axle associated with at least one wheel of a pair wheels, wherein said axle is retained by the main body and is moved away from the main body under the action of a biasing force applied by a biasing means.

The present invention is adapted to provide a panel carriage. Such a panel carriage can be associated with a window or door to be installed into a joinery system, where the carriage provided allows the window or door to slide along a pair of rails forming a track in the joinery. Sliding panel joinery systems may be implemented using the panel carriage provided to preferably allow panels to be easily removed or installed into the window or door joinery provided.

Reference throughout this specification will be made to the joinery system involved including a track on the head or top portions of the joinery, thereby implementing a top rolling sliding panel door or window. However, those skilled in the art should appreciate that other types of sliding panel joinery systems may also be implemented using the panel carriage discussed below, and reference to the above only throughout the specification should in no way be seen as limiting. For example, if required, a bottom rolling sliding panel may also be implemented using the carriage of the present invention.

Reference in the main will also be made throughout this specification to the present invention being used with exterior joinery systems. However, again those skilled in the art should also appreciate that the present invention may be used in a number of different or alternative applications which each employ a moving panel and preferably a track system along which such a panel may move.

Preferably the carriage includes a main body. The main body can form an enclosure, housing or frame to the remaining portions of the carriage, and in use is preferably disposed between the two rails of the track along which the carriage is to move.

In a preferred embodiment the carriage may include a single pair of wheels only with a wheel of each pair being located on opposite sides of the main body. A wheel as employed in conjunction with the present invention can include a tyre to run on an aluminium track, or alternatively a wheel may be provided by a simple bearing if required.

In a further preferred embodiment a carriage may include a single pair of wheels only formed by a single pair of bearings applied to the carriage.

In a further preferred embodiment the contact surfaces of the wheels or bearings employed may be cambered or angled to engage with a corresponding angled contact surface of a rail on which a wheel is to run. Cambering the wheels surfaces allows accurate placement and engagement of a carriage on the track, ensuring that the carriage and associated panel are sited centrally within the joinery and to also compensate for any potential misalignment of the track.

Reference throughout this specification will also be made to a panel carriage including a single pair of wheels only, with a wheel located on each opposed side of the carriage and aligned with the direction of travel in which the carriage is to move. However those skilled in the art should appreciate that multiple pairs of wheels may be provided on a single carriage if required and reference to the above only throughout the specification should in no way be seen as limiting.

Preferable an adjustable linkage may locate each wheel with respect to the main body. An adjustable linkage as used in conjunction with the present invention can allow movement of a wheel towards and away from the main body.

In a further preferred embodiment an adjustable linkage may be formed by an axle associated with one or more wheels of the carriage. The axle employed may be enclosed or otherwise held in place by the main body and provide a mounting for at least one wheel. Furthermore, such an axle may be movable laterally within the main body to provide the adjustable linkage required.

For example, in some preferred embodiments at least a portion of the main body may be formed as a cylindrical or generally hollow housing for an axle which mounts a single wheel only. This axle may be free to move in and out of the hollow main body to in turn allow the lateral movement required of the wheel towards and away from the main body.

Reference throughout this specification will also be made to an adjustable linkage including an axle associated with a single wheel which is located or enclosed by a cylindrical portion of the main body. In such a preferred embodiment a pair of such axles may be provided for the pair of wheels involved to form the adjustable linkage. However, those skilled in the art should appreciate that other configurations of the adjustable linkage required are also envisioned and reference to the above only throughout the specification should in now way be seen as limiting.

In a preferred embodiment the present invention may include at least one wheel retention means adapted to locate or fix the position of at least one wheel with respect to the main body. In a further preferred embodiment such a wheel retention means may also be used to, or adapted to allow, the position at the wheel to be controlled with respect to the position of the main body.

In one embodiment the panel carriage may also include at least one biasing means, where a biasing means may be associated with one or more wheels of the carriage. In such an embodiment, a biasing means may form a wheel retention means as discussed above. A biasing means may be adapted to apply a continuous biasing force to an associated wheel to in turn urge or force the wheel away from the main body of the carriage.

In a further preferred version of such an embodiment a biasing means may act on or apply a biasing force to the adjustable linkage of the wheel to indirectly apply a biasing force to the wheel and urge same out away from the main body of the carriage.

Preferably the magnitude of the biasing force applied by a biasing means may be selected so that this force can be overcome or neutralised by the application of an external force to the wheels of the carriage. Such an external force may be directed to urge the wheels towards the main body of a carriage in opposition to the biasing force applied. This external force will therefore overcome the biasing force and urge the wheels in towards the panel carriage and therefore the wheels off the rails and track of the joinery system. In this way an external force can be used to allow the panel associated with the carriage to be removed from the joinery provided.

In a preferred embodiment a biasing means may be formed by a compression spring located in the interior of the main body and positioned so as to allow compression of the spring by the ends of the linkage axles within the main body. Movement of the wheels in towards the main body of the carriage will then compress the biasing spring provided, forcing same into apply a biasing force outwards onto the stub or free ends of the axle linkages, therefore applying an outward biasing force to each of the wheels.

In such embodiments incorporating a biasing means, the panel carriage may also include a locking means adapted to fix a maximum distance that a wheel can travel away from the main body. This locking means may act on one or both of the pair of wheels of the carriage to counteract the biasing force applied to each wheel. Such a locking means employed in association with each wheel will in turn dictate the maximum wheel span or width of the carriage and locate the wheels correctly so that they will engage with the rails of the joinery track.

In further preferred versions of such embodiments a single locking means may be associated with each wheel through the provision of a projecting pin, rod or extension from a side wall of an adjustable linkage axle. This projecting axle pin may slide within the channel formed in the main body, where the length of the channel provided will dictate the maximum distance that the linkage axle can travel out of the main body. This projecting pin will therefore act as a stop against further movement of the wheel once it reaches the end of the channel and therefore counteract or block a biasing force applied to the wheel by the biasing means.

A panel carriage as discussed above can therefore be removed from its surrounding joinery through the application of an external force to the wheels of the carriage.

Preferably, in such embodiments an extraction tool may be employed to apply such an external force to compress the carriage wheels and subsequently remove the panel from the joinery system. In these instances the wheels of a carriage are adapted to engage with at least one contact surface of the extraction tool where this contact surface or surfaces are used to force the wheels of a carriage together towards the main body as a carriage is moved towards the extraction tool. Such a tool may be inserted into the joinery track involved at a position where the carriage will intersect with the tools contact surface or surfaces as it is run along the track. The tool provided may preferably include a contact surface or surfaces which engage with the carriage wheels and effectively reduce the width of the track to push the wheels inwards as they are moved forward towards the extraction tool.

In one embodiment the contact surfaces of the extraction tool may be cambered or angled downwards with respect to the joinery track which the tool is to be inserted into. This angling of contact surfaces will apply both a lateral and also downward force to the carriage wheels as they are pushed or pulled into contact with the tool contact surfaces, thereby compressing the carriage wheels and pushing the entire carriage body out of the area defined by the joinery track. However, in other instances the contact surface or surfaces of the tool may be orientated substantially perpendicular to the track involved.

However, in a preferred embodiment the present invention may not employ at least one biasing means substantially as described above. For example, in a further alternative (and potentially preferable embodiment in some applications) a wheel retention means may not necessarily employ a biasing means adapted to apply a continuous biasing force to urge a wheel away from the main body. In such embodiments the panel carriage provided need not necessarily require the application of an external force (through the provision of an extraction tool as discussed above) to assist in the removal of the panel carriage from surrounding joinery.

For example, in one such embodiment a wheel retention means may be formed by or include a retention projection which is adapted to extend through a retention channel or slot formed within the main body. A retention projection may also travel through an aperture formed within an adjustable linkage axle, with this aperture having approximately the same width or diameter as that of the retention projection. Such a projection may be angled with respect to the orientation of the main body and linkage axle involved so that movement of the projection through the retention channel will cause an effective lateral movement along the channel of the section of the projection within the retention channel. This in turn will cause the side of such a projection to push against the surface of the aperture formed in an adjustable linkage axle, to in turn supply an urging force to move the wheel and axle in or out with respect to the main body.

In a preferred embodiment an angled retention projection may be provided for each wheel associated with the main body.

In a further preferred embodiment a pair of linked, angled retention projections may be provided for each of the pair of wheels integrated with in a carriage. In such an instance, the two projections involved may form a fork or V shaped element, with the free, divergent ends of the projections being linked by a finger pull operable by a user. In such instances if the linking finger pull is adjacent to the pair of axles, the wheels involved will be located at their furthest position with respect to the main body of the carriage. Conversely if the finger pull is grasped by a user and pulled away from the main body, this will in turn change the lateral position of each projection within the retention channel of the main body, engaging the side of each projection with the interior end of the aperture in the axle through which the projection is threaded. This will in turn pull the axle towards the main body of the carriage.

In such embodiments the provision of a user operable finger pull eliminates the need for a panel extraction tool to be provided when removing the panel from its surrounding joinery. Each finger pull associated with a pair of wheels may be moved by a user depending on whether the wheels involved are to be engaged with the track and the joinery, or pulled inwards to allow the panel to be removed. In such instances once the wheels of a carriage are pulled inwards towards its main body the panel may simply be dropped out of or lifted out of its surrounding joinery.

In such embodiments an alternative form of locking means may also be provided for each wheel. For example, a locking means may be implemented through a locking projection on the main body, where this locking projection is adapted to locate the finger pull in contact with the main body. In such instances a locking projection may be located a distance from a side wall of the main body, where this side wall defines a region in which at least one adjustable linkage axle is located within the main body. A space between the locking projection and such a side wall may be provided large enough to accommodate the finger pull. To lock the finger pull in place, it may be pushed over such a locking projection to then place a surface of the finger pull in contact with such a side wall of the main body.

The use of a panel carriage substantially as described above also allows some modifications to be made to the joinery profiles employed to mount a panel. For example, in some instances, the sill profile of the joinery (which does not need to carry any panel based loads), can be formed as a substantially flat and preferably sloping surface above which the bottom edge of a panel is to hang. The provision of flat sloping surface ensures that the sill joinery is comparatively easy to clean and does not trap dirt or dust or other contaminants in a bottom rolling track.

This flat or sloping design can also promote the aesthetic appeal or appearance of the overall resulting joinery. In addition, a sloping sill profile will give further clearance space to the bottom edge of the panel as it is dropped out, down and away from the joinery during removal.

In addition, in further preferred embodiments modifications may also be made to the configuration of the rails forming the track in the head joinery profile. In such instances, wires or runners formed from a durable material may be mounted on the top surfaces of each rail to provide a contact surface for each wheel of the carriage. For example, steel wires can provide a durable bearing surface over which the carriage wheels can roll, potentially to increase the overall lifespan and durability of the track formed in the head joinery profile.

However, those skilled in the art should appreciate that standard or conventional types of wheel and tyre arrangements may also be employed in conjunction with the present invention if required. For example, in some instances conventional carriage wheels with grooved tyres may also be employed as an alternative to the system disclosed above.

The present invention may provide many potential advantages over existing prior art panel carriages and associated joinery profiles which employ same.

The use of a carriage as discussed above allows a sliding panel to be easily and quickly inserted into sliding panel joinery. In some embodiments the wheels of the carriage simply need to be pushed together against any biasing force acting on them and the panel manoeuvred and positioned into place within a track in the joinery. When released the wheels provided will then move outwards and lock into place at the correct width to engage with the joinery track.

In such instances a panel supported by such carriage may also easily be removed through the application of an external force which compresses the wheels of a carriage together. This will in turn move the wheels off the rails of the joinery track and allow the carriage to drop out of the track and be pulled and pivoted out of the surrounding joinery.

However, in alternative embodiments the carriage may be provided with one or more sets of retention projections as opposed to the biasing means discussed in the above implementation. In such instances a finger pull associated with one or more of these retention projections may be grasped and moved by a user to in turn move the wheels of the carriage off the rails of the joinery track, or vice versa. In such instances it is no longer a requirement for either the panel to be moved in a removal operation, or for a separate extraction tool to be provided.

This configuration of the present invention allows both easy installation and also removal of the panel at any stage in the construction and also lifespan of the joinery involved. Furthermore, the panel carriage discussed above and implemented in conjunction with the present invention eliminates the need for a wheel removal notch to be machined into any portions of the joinery, therefore promoting an anaesthetically pleasing and attractive finished joinery system.

### BRIEF DESCRIPTION OF DRAWINGS

Further aspects of the present invention will become apparent from the following description which is given by way of example only and with reference to the accompanying drawings in which:

FIG. 1a shows a side cross section view of a panel carriage as configured in accordance with a preferred embodiment, and

FIG. 1b shows a perspective view of an extraction tool employed to remove the panel carriage shown with respect to FIG. 1a, and

FIG. 1c shows both the panel carriage and extraction tool of FIGS. 1a and 1b.

FIG. 2 shows a side cross section view of the panel carriage of FIG. 1 when installed in a joinery system, and

FIG. 3 shows a side cross section view of the panel carriage of FIG. 1 when installed in an alternative joinery system to that shown with respect to FIG. 2, and

FIGS. 4A, 4B, 4C show a top view, side cross section view and cross section end view of a panel carriage which uses a pair of wheel retention projections, where these projections are shown extending the wheels of the panel carriage outwards, and

FIGS. 5A, 5B, 5C show a top view, cross section view and cross section end view of a panel carriage which uses a pair of wheel retention projections, where the wheel retention projections are shown retracting the panel carriage's wheels off the joinery track provided.

### BEST MODES FOR CARRYING OUT THE INVENTION

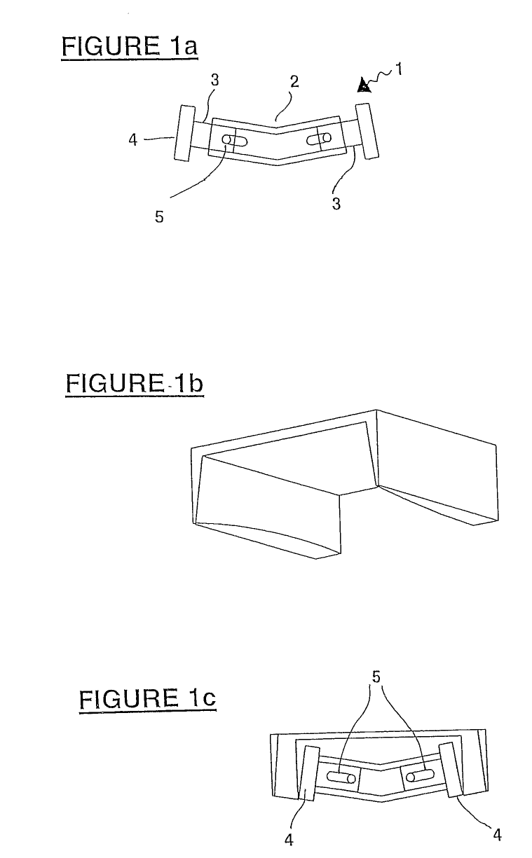

FIG. 1 shows a front cross section view of a panel carriage (1) as configured in accordance with a preferred embodiment of the present invention.

The carriage (1) includes a main body (2) which is formed by two substantially hollow cylindrical sections joined at a central axis for the carriage.

A pair of adjustable linkage axles (3) are inserted into the hollow ends of the carriage (2) where a wheel or bearing (4) is located and directly connected to the far end of each linkage axle (3). Each linkage axle (3) is free to slide in and out of the interior of the hollow sections of the main body (2). This in turn allows each wheel (4) associated with a linkage axle to move towards and away from the main body (2).

The carriage (1) also includes a biasing means (not shown) normally implemented through a compression spring located in the interior or closed sections in the main body (2). The free ends of this biasing spring are compressed by the stub ends of each linkage axle when the wheels (4) are moved in towards the main body (2). This compressed biasing spring will in turn apply an outwardly directed biasing force onto the wheels (4).

The carriage (1) also includes a pair of locking mechanisms (5) which are configured to lock each wheel (4) and a maximum distance away from the main body (2). In the embodiment illustrated by FIG. 1, each locking mechanism is implemented through a projecting pin mounted on the exterior surface of a linkage axle. This pin can project through and into a slot formed in the interior of the main body housing for the linkage axle with the length of the slot determining the distance or maximum displacement outwards that a linkage axle and its associated wheel can travel with respect to the main body. Each locking means (5) will therefore dictate the maximum width of the carriage.

FIG. 1b shows a perspective view of an extraction tool employed to remove the panel carriage shown with respect to FIG. 1a from a joinery track.

As can be seen from FIG. 1b, this extraction tool includes internal contact surfaces which slowly reduce the internal span or diameter of cavity formed by the tool in both the horizontal and vertical directions. This will then force the wheels of a carriage intersecting with a head and front of a tool to be pushed inwards and also to apply a gentle downward force onto the carriage.

The action of this extraction tool shown can be clearly seen with respect to FIG. 1c which shows both the panel carriage and extraction tool, where the tool is used to remove the carriage from the joinery.

From FIG. 1c it can be seen that the wheels (4) of the carriage have been moved in towards the main body by the external force applied by the side contact walls of the extraction tool as the carriage is moved into the interior cavity of same. As the wheels are moved inwards, this forces the projecting pin of each locking mechanism inwards as well. This compresses the overall carriage form and reduces its width in addition to placing a gentle downward force on same to facilitate the removal of the carriage from the surrounding joinery.

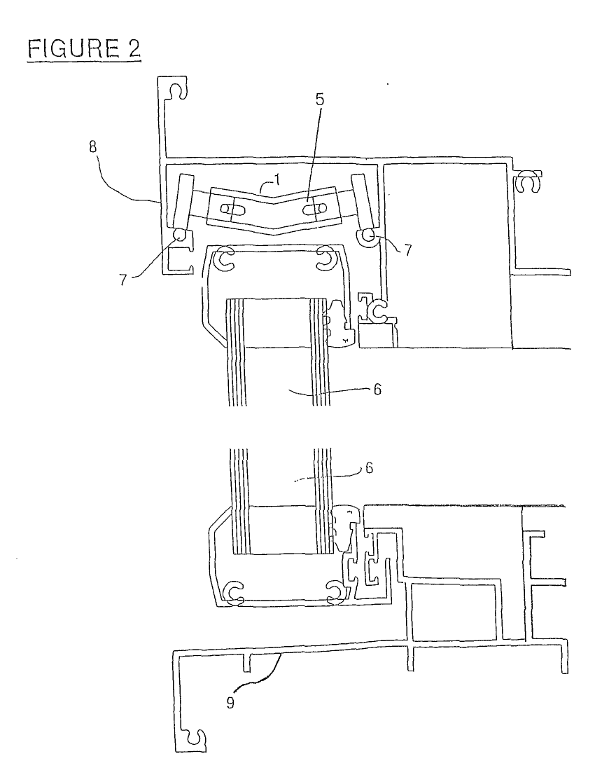

FIG. 2 illustrates a side cross section view of the panel carriage of FIG. 1 when installed with a joinery system. A discontinuity is shown with respect to the head and sill portions of the joinery assembly to illustrate an indeterminant or variable height joinery panel (6).

The joinery system shown with respect to FIG. 2 implements a top rolling panel slider where the carriage (1) rolls along a pair of rails (7) forming a track within the head (8) of the head profile of the joinery.

As can be seen from FIG. 2, compression or movement of the wheels (4) in towards the main body (2) will allow the carriage to be dropped out from the track formed and away from each of the rails (7) to remove the carriage and its associated panel (6) from the interior of the joinery. Conversely, the same panel can be easily inserted back into the joinery through compression of the carriage wheels (4) which will subsequently spring back into the form or configuration shown with respect to FIG. 2 under the action of the biasing means spring discussed above. The locking means (5) provided will then lock each wheel in the position shown to position the wheels on the rails of the joinery track.

As can also be seen from FIG. 2, each of the bearings or contact surfaces of the wheels (4) are angled or cambered to engage with the angled or cambered surfaces of each rail (7). Furthermore, each rail (7) includes a steel wire insert which provides a durable contact surface material over which the wheels (4) are run to increase the durability of the resulting rails and the track.

As can also be seen from FIG. 2, the provision of a top rolling carriage allows the bottom sill face (9) of the joinery assembly to be formed as a substantially flat and gently sloping surface. This flat sloping surface can be easily cleaned and also provides an additional clearance space for the panel when it is to be removed and dropped out from the surrounding joinery and subsequently pivoted away from same.

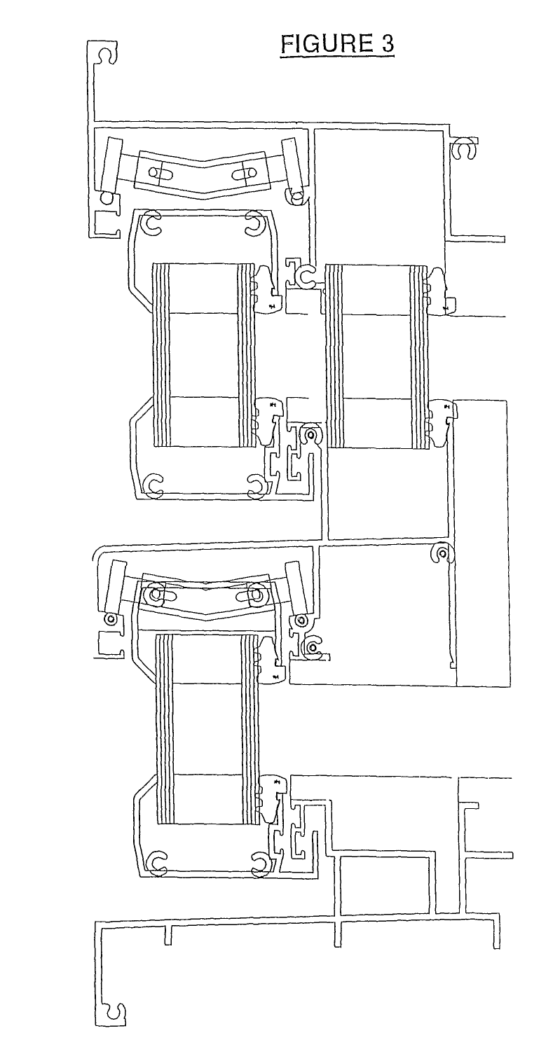

FIG. 3 shows a side cross section view of the panel carriage of FIG. 1 when installed in an alternative joinery systems to that discussed with respect to FIG. 2.

As can be seen from FIG. 3, the same carriage can be used in multiple panels of a joinery assembly. Various different types of joinery assemblies may employ a panel carriage as configured in accordance with the present invention.

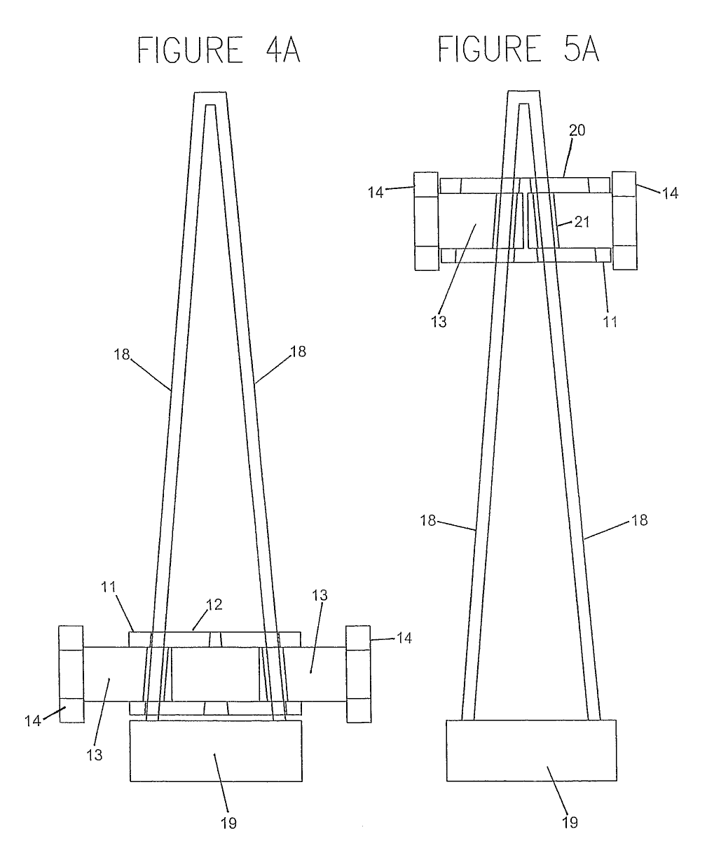

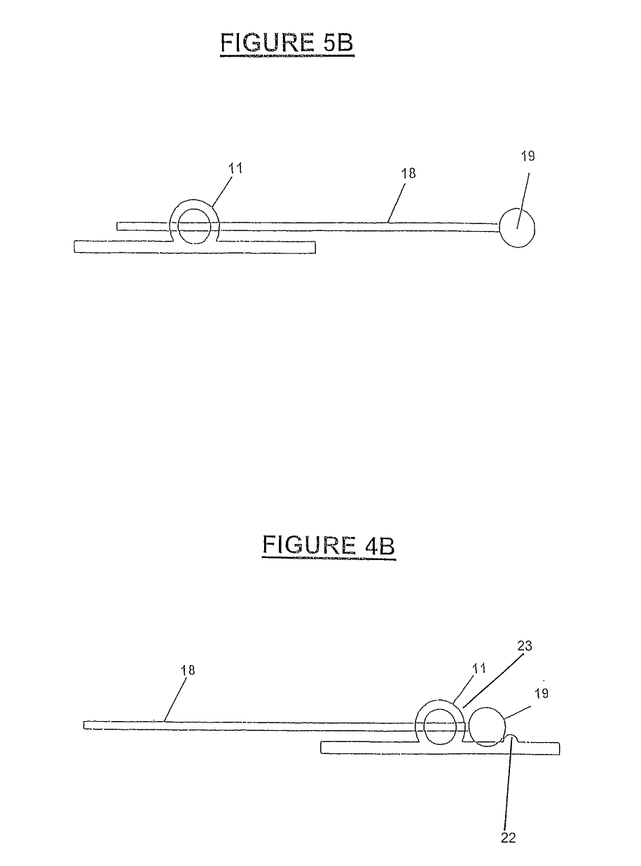

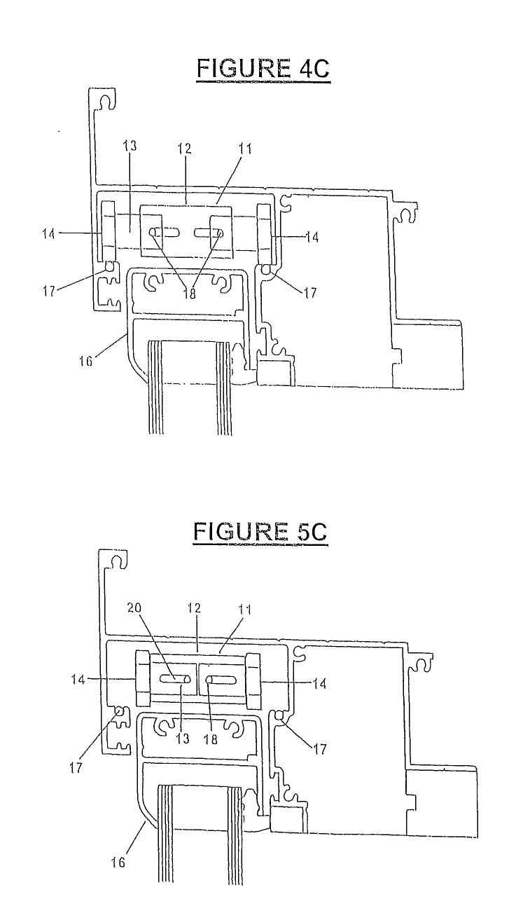

FIGS. 4A and 5A show top views of a panel carriage (11) which includes an alternative wheel retention system to that discussed with respect to the previous FIGS. 1 though 3. Alternative views of the same panel carriage (11) are provided in the form of FIGS. 4B and 5B as cross section side views, and FIGS. 4C and 5C as cross section end views of the same panel carriage (11) when associated with a panel (16).

These figures show the provision of a pair of wheel retention projections (18) formed as an inverted V shape and linked together at their free ends via a finger pull (19).

In all other respects the panel carriage (11) still includes a main body (12), a pair of axles (13) and wheels (14), where these wheels are configured to sit on and roll along a rail within an associated joinery system.

Each projection (18) is configured to pass through a retention channel or slot (20) provided within the main body (12). These channels (20) run in the same direction or orientation of each axle and have each projection (18) running through each slot at an angle.

Each projection (18) also runs through an aperture (21) formed in the end of each axle (13). The diameter or width of each of these apertures (21) is approximately equal to that of the projection (18) involved. Each aperture (21) is also angled with respect to the orientation of the body of each axle (13).

The action of the angled projection (18) is illustrated through the differences between FIGS. 4A through 4C and FIGS. 5A through 5C. In the situation shown with respect to FIGS. 4A through 4C the finger pull (19) is positioned adjacent to the main body of the carriage. This forces each axle outwards through the finger pull end of each projection pushing each axle outwards. Conversely in the situation shown with respect to FIGS. 5A through 5C the opposite apex end of each projection is pulled in towards the interior end of each retention channel (20), thereby pulling the axles inward and removing the wheels (14) from the rail (17).

As can be seen from FIGS. 4A through 4C and 5A through 5C a panel carriage (11) may be easily and quickly derailed without the assistance of any external ejection system. The panel also need not be moved laterally along the rail (17) during such an ejection operation.

FIG. 4B also illustrates the action of a locking means employed in the embodiment of the invention shown. In this embodiment a locking projection (22) is provided a distance away from a side wall (23) of the main body, where this side wall defines a portion of the main body which locates a linkage axle. As can be seen from FIG. 4B the finger pull (19) can be pushed over the locking projection (22) to engage a surface of same with that of the side wall (23). The finger pull (19) will then be locked in place between the side wall (23) and the locking projection (22). As can be seen from FIG. 4B when the finger pull (19) is locked or located in this position, the wheels (14) of the carriage will be extended outwards to engage with a track.

Aspects of the present invention have been described by way of example only and it should be appreciated that modifications and additions may be made thereto without departing from the scope thereof.

1. A panel carriage adapted to traverse a pair of rails forming a track within a joinery system, the carriage including,
a main body, and
at least one pair of wheels, with a wheel of each pair being located on opposite sides of the main body, and
an adjustable linkage associated with each wheel,
wherein an adjustable linkage is adapted to locate at least one wheel on a side of the main body, and is adapted to allow movement of a wheel either towards or away from the main body.

2. A panel carriage as claimed in claim 1 wherein the carriage is adapted to support a sliding panel.

3. A panel carriage as claimed in claim 2 wherein the carriage is adapted to support a top rolling sliding panel.

4. A panel carriage as claimed in claim 3, wherein the carriage includes a single pair of wheels with wheels located on opposite sides of the main body.

5. A panel carriage as claimed in claim 4, wherein a contact surface of a wheel is angled to correspond with an angled contact surface of the rail which said wheel is adapted to traverse.

6. A panel carriage as claimed in claim 5, wherein an adjustable linkage includes at least one axle associated with at least one wheel.

7. A panel carriage as claimed in claim 6 which includes an adjustable linkage formed by a pair of axles, with each axle of the pair being associated with a wheel of the carriage.

8. A panel carriage as claimed in claim 7 wherein an axle of the adjustable linkage is free to move laterally within the interior of the main body.

9. A panel carriage as claimed in claim 1, which includes a wheel retention means adapted to position at least one wheel with respect to the main body.

10. A panel carriage as claimed in claim 9 wherein a wheel retention means includes a retention projection which extends through an aperture formed within an adjustable linkage axle and a retention channel formed within the main body.

11. A panel carriage as claimed in claim 10 wherein a retention projection is angled with respect to the main body so that movement of the projection through the retention channel causes movement along the channel of the section of the projection within the retention channel.

12. A panel carriage as claimed in claim 11 wherein the section of the projection within the retention channel is adapted to bear against an end wall of the aperture formed within the adjustable linkage axle to move the adjustable linkage axle with respect to the main body.

13. A panel carriage as claimed in claim 12 wherein an angled retention projection is provided for each wheel associated with the main body.

14. A panel carriage as claimed in claim 13 wherein the carriage includes a pair of connected retention projections adapted to form a ‘v’ shaped element, where the divergent ends of the projections are connected together with a finger pull.

15. A panel carriage as claimed in claim 14 which includes a locking means formed from a locking projection provided on the main body, said locking projection being adapted to locate the finger pull in contact with the main body.

16. A panel carriage as claimed in claim 1 wherein a wheel retention means is formed by at least one biasing means associated with each pair of wheels,
said at least one biasing means being adapted to apply a continuous biasing force to urge at least one wheel away from the main body,
wherein the biasing force applied is adapted to be overcome by an external force acting to move a wheel towards the main body.

17. A panel carriage as claimed in claim 16 wherein a biasing means is formed by a compression spring located within the interior of the main body so that movement of an adjustable linkage axle towards the main body will compress the biasing spring.

18. A panel carriage as claimed in claim 17 which includes a locking means adapted to counteract a biasing force applied by a biasing means, said locking means being adapted to lock a wheel a fixed maximum distance away from the main body.

19. A panel carriage as claimed in claim 18 wherein a locking means is provided by a locking projection pin extending from a side wall of an adjustable linkage axle, said locking pin being adapted to move within a channel in the main body, wherein the length of said channel dictates the maximum distance the adjustable linkage axle can travel out from the main body.

20. A panel carriage as claimed in claim 19 wherein the wheels of the carriage are adapted to engage with at least one contact surface of an extraction tool, said contact surface being adapted to force the wheels towards the main body as the carriage is moved towards said extraction tool.

21. A panel carriage as claimed in claim 20 wherein said extraction tool is adapted to be inserted into the track of a joinery system.

22. A panel carriage as claimed in claim 21 wherein said at least one contact surface of the extraction tool is angled with respect to the track into which the extraction tool is to be inserted.

23. A panel carriage as claimed in claim 21 wherein said at least one contact surface of the extraction tool is orientated substantially perpendicular to the track into which the extraction tool is to be inserted.

24.-25. (canceled)
